(19) United States
(12) Patent Application Publication
(10) Pub. No.: US 2008/0123096 A1
(43) Pub. Date: May 29, 2008

(54) Optical system for alignment assembly of field emission display panel

(76) Inventors: Tien-Sung Liu, Taipei (TW); Frank Yang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/594,206

(22) Filed: Nov. 8, 2006

(51) Int. Cl. G01B 11/00

(52) U.S. Cl. 356/400

(57) ABSTRACT

An optical system for alignment assembly of a field emission display panel comprises an optical lens tube, a lens unit, an image conversion unit and an image processing and display unit. The lens unit has at least two optical lenses corresponding to a first outlet end and a second outlet end of the optical lens tube, respectively. A reflective translucent lens is disposed in the optical lens tube to correspond to the inlet end and the first and second outlet ends. The reflective translucent lens transmits several optical signals generated during alignment of the anode and cathode substrates to the lens unit. The image conversion unit and the image processing and display unit are used to display the image captured by the optical lenses on the same display, thereby accomplishing image capture and alignment reference for reference points of the anode and cathode substrates at different focus depths.

### BACKGROUND OF THE INVENTION

1. Field of the invention

The present invention relates to an optical system for alignment assembly of a field emission display panel and, more particularly, to an optical system for alignment assembly of a field emission display panel, which system makes use of a plurality of optical lenses to accomplish image capture and alignment for reference points of the anode and cathode substrates at different focus depths.

2. Description of Related Art

A carbon nanotube field emission display is based on the principle of field emission, and makes use of electric field to attract electrons at the tips of emission sources of the cathodes of carbon nanotubes. In vacuum, field emission electrons are attracted and accelerated by the positive voltage of the anodes on the upper glass substrate to constantly accumulate energy and finally bombard the corresponding phosphor to emit light.

The display device is composed of a cathode substrate and an anode substrate. For a large-size and high-resolution structure, precise alignment of the anode and cathode substrates is very important. In the fabrication technology, field emission display panels differ from liquid crystal display panels and plasma display panels. Field emission displays are vacuum displays. Vertical gaps in the structure will affect the electric field and the light emission efficiency. Therefore, in addition to the alignment mechanism and resistant factors against the formed vacuum structure, it is also necessary to take the flatness and horizontal uniformity of the panel into account after packaging of the anode and cathode substrates.

The anode and cathode substrates need to be packaged by means of alignment assembly to form a closed region, and the closed region is vacuated to form a vacuum state. Because the anode and cathode substrates are large-size and flat, in order to prevent the anode and cathode substrates from deforming or even breaking due to the external atmospheric pressure, it is necessary to provide an insulating spacer or a rib between the anode and cathode substrates to keep the supporting force between them and avoid the electric conduction between wires of the anode and cathode substrates.

In the conventional alignment assembly process of the anode and cathode substrates, separate coating and then aligned sealing are performed to the anode and cathode substrates. There are many restrictions on the aligned sealing. For instance, during alignment assembly process, coating (e.g., the phosphor layer of the anode substrate, and the electron emission source layer of the cathode substrate) not harmful to the surfaces of the anode and cathode substrates has to be adopted. Besides, because there are a certain amounts of spacers distributed on the panel, the alignment process needs to be done with much cautiousness.

In order to ensure a frictional contact of the anode and cathode substrates with the spacers, it is necessary to keep a specific gap between the anode and cathode substrates during alignment to avoid damage.

In the alignment assembly operation, alignment reference points are provided on the anode and cathode substrates, and an optical detection system is used to adjust the shift of the anode and cathode substrates to overlap the alignment reference points so as to accomplish alignment of the anode and cathode substrates. The anode and cathode substrates are then assembled together.

There are many spacers between the anode and cathode substrates. The height of the spacers usually is kept to at least 1.1 mm between the anode and cathode substrates (i.e., the height of the spacers has to be at least 1.1 mm). As for the optical technology, the difference between the depths of field of the two reference points at the focus depths is large, and is even larger than 1.1 mm. A general optical lens for alignment has a limited range (usually within several hundreds of micrometers) for capturing images that has a higher precision of the focus range. That is, the depth of field has a higher precision but a narrow range. Therefore, it is difficult to use an optical lens to simultaneously capture images of the alignment reference points at different focus depths of the anode and cathode substrates.

FIG. 1 is a diagram of a conventional optical system for alignment assembly of a field emission display panel. As shown in FIG. 1, a first movable platform 1a and a second movable platform 2a corresponding to each other are disposed on an anode substrate 100a and a cathode substrate 200a, respectively. The anode substrate 100a and the cathode substrate 200a have an anode reference point 110a and a cathode reference point 210a, respectively. The first and second movable platform 1a and 2a has a first through hole 10a and a second through hole 20a corresponding to the anode reference point 110a and the cathode reference point 210a, respectively.

The above conventional optical system for alignment assembly of a field emission display panel comprises a first optical lens 3a disposed on the first movable platform 1a and corresponding to the first through hole 10a, a second optical lens 4a disposed on the second movable platform 2a and corresponding to the second through hole 20a, two image conversion units 5a, a reference alignment unit 6a, an image overlap unit 7a, and a monitor 8a. The two image conversion units 5a are electrically connected to the first and second optical lenses 3a and 4a, respectively. The two image conversion units 5a are also connected to the reference alignment unit 6a. The reference alignment unit 6a is electrically connected to the image overlap unit 7a. The image overlap unit 7a is electrically connected to the monitor 8a.

Through horizontal shift of the first movable platform 1a and the second movable platform 2a, the anode reference point 110a of the anode substrate 100a and the cathode reference point 210a of the cathode substrate 200a are aligned. During the alignment process of the anode reference point 110a and the cathode reference point 210a, the generated focused optical signals can be transmitted to the first optical lens 3a and the second optical lens 4a, respectively. The first and second optical lenses 3a and 4a then transmit the optical signals to the image conversion units 5a, which convert them to an electronic signal. The reference alignment unit 6a and the image overlap unit 7a are then used to perform image alignment and overlap operations to the electronic signal. The aligned and overlap image is then displayed on the monitor 8a to accomplish the simulation of optical alignment of the anode and cathode substrates 100a and 200a.

When the above conventional optical system performs alignment and image capture to the reference points of the anode and cathode substrates, the optical system can utilize at least two sets of optical lenses to separately capture images of the alignment reference points. A reference unit and the image overlap technology are then used to accomplish the simulation of optical alignment of the anode and cathode substrates.

However, during the alignment process of the reference points of the anode and cathode substrates, the generated focused optical signals are converted to the electronic signal for alignment and overlap by using at least two optical lenses, the image conversion unit, the reference alignment unit and the image overlap unit. Therefore, the relative relation and precision of the reference alignment unit is very important. Moreover, the user has to constantly calibrate the relative relationship and precision of the reference alignment unit to make sure that an accurate alignment can be acquired.

In another conventional optical system for alignment assembly of a field emission display panel, a single optical zoom lens is used. The optical lens is first focused at the alignment reference point of the anode or cathode substrate, and the movable platform or the optical lens is horizontally moved to overlap the alignment reference point and the center of the optical lens. The optical mechanism or the panel mechanism are then held stationary. Next, the optical lens is used to capture the image and focus at the alignment reference point of the other substrate. At this time, the other mechanism is shifted and aligned with the center of the optical lens. The alignment actions of the anode and cathode substrates are thus finished.

However, in the above conventional optical system, the reliability of the reference alignment unit needs to be very high. Moreover, the operation of this optical alignment system is more cumbersome and difficult, and depends on high operation technique of the user and precise optical alignment. Therefore, the above optical system cannot effectively maintain a good alignment assembly state for a long time.

### SUMMARY OF THE INVENTION

An object of the present invention is to provide an optical system for alignment assembly of a field emission display panel. The optical system makes use of a plurality of optical lenses in a single optical lens tube to align reference points on the anode and cathode substrates at different focus depths so as to accomplish image capture and alignment.

Another object of the present invention is to provide an optical system for alignment assembly of a field emission display panel. The optical system utilizes a plurality of optical lenses of the same set of alignment reference points used for a coaxial optical image to make image capture of these optical lenses concentric, thereby getting the same image range. Moreover, collocated with the image overlap processing technology, the optical images captured by these optical lenses can be jointly input to the same display to accomplish the object of alignment.

To achieve the above objects, the present invention provides an optical system for alignment assembly of a field emission display panel. The optical system is used for the alignment of reference points of an anode substrate and a cathode substrate. The anode and cathode substrates are disposed on a first platform and a second platform, respectively. The optical system comprises an optical lens tube, a lens unit, an image conversion unit and an image processing and display unit. The optical lens tube is disposed on the first platform. The optical lens tube has an inlet end, a first outlet end, a second outlet end and a reflective translucent lens. The inlet end corresponds to the reference point of the anode substrate. The reflective translucent lens is disposed in the optical lens tube and corresponds to the inlet end, the first outlet end and the second outlet end. The lens unit has at least two optical lenses respectively corresponding to the first and second outlet ends. The image conversion unit is connected to the lens unit, and is used to convert optical signals to an electronic signal. The image processing and display unit is electrically connected to the image conversion unit, and is used to generate and display the electronic signal on the same frame.

The first platform moves horizontally relative to the second platform to align the reference points of the anode and cathode substrates so as to produce two optical signals, which are transmitted to the reflective translucent lens via the inlet end and then respectively transmitted to the optical lenses at the first outlet end and the second outlet end via the reflective translucent lens. The image conversion unit then converts the optical signals to the electronic signal. The image processing and display unit finally generates and displays the electronic signal on the same frame to accomplish optical alignment.

The optical lenses of the same set of alignment reference points can get a common center and an image capture range of the same area to align reference points on the anode and cathode substrates at different focus depths, thereby accomplishing image capture and alignment.

### BRIEF DESCRIPTION OF THE DRAWINGS

The various objects and advantages of the present invention will be more readily understood from the following detailed description when read in conjunction with the appended drawing, in which:

FIG. 1 is a diagram of a conventional optical system for alignment assembly of a field emission display panel; and

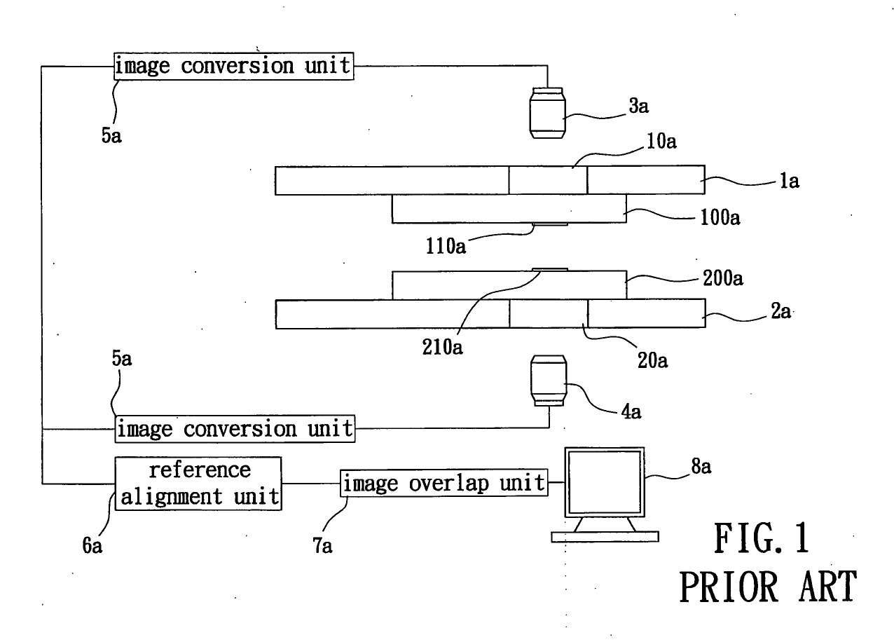

FIG. 2 is a diagram of the optical system for alignment assembly of a field emission display panel of the present invention.

### DETAILED DESCRIPTION OF THE PREFERRED EMBODIMENTS

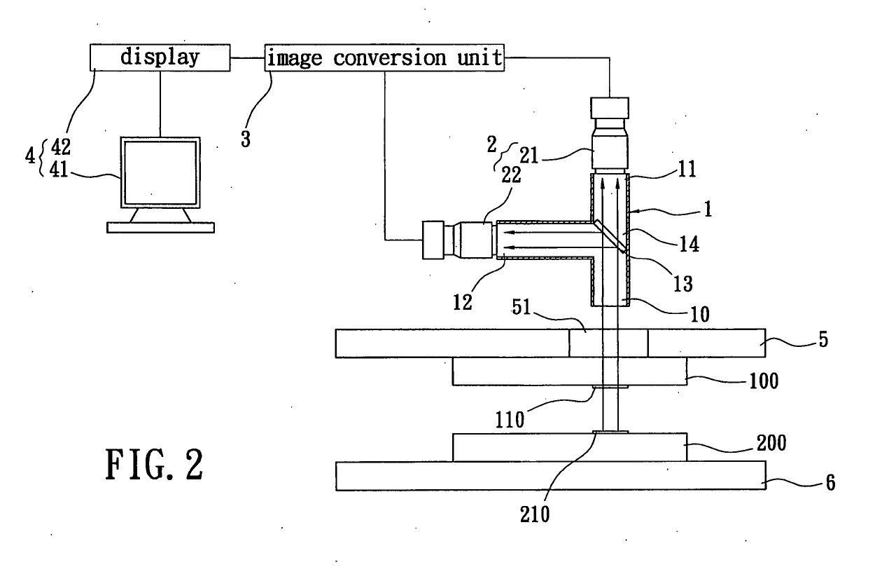

FIG. 2 is a diagram of the optical system for alignment assembly of a field emission display panel of the present invention. As shown in FIG. 2, the optical system is used to align an anode reference point 110 of an anode substrate 100 and a cathode reference point 210 of a cathode substrate 200 to achieve optical alignment of the anode and cathode substrates 100 and 200. The optical system comprises an optical lens tube 1, a lens unit 2, an image conversion unit 3 and an image processing and display unit 4.

In this embodiment, the anode substrate 100 and the cathode substrate 200 are disposed on the bottom surface of a first platform 5 and the top surface of a second platform 6, respectively. The first platform 5 is a movable platform while the second platform 6 is a stationary platform (or the first platform 5 is a stationary platform while the second platform 6 is a movable platform, or both the first and second platforms 5 and 6 are movable platforms). The first platform 5 has a through hole 51 corresponding to the anode reference point 110.

In this embodiment, the optical lens tube 1 and the lens unit 2 are joined together and fixedly disposed on the top surface of the first platform 5. The optical lens tube 1 has an inlet end 10 corresponding to the through hole 51, a first outlet end 11, a second outlet end 12 and a reflective translucent lens 13. The inlet end 10 corresponds to the anode reference point 110 of the anode substrate 100 via the through hole 51. The reflective translucent lens 13 is disposed at a branch position 14 in the optical lens tube 1 to correspond to the inlet end 10, the first outlet end 11 and the second outlet end 12. The reflective translucent lens 13 can receive optical signals generated during focusing and alignment of the anode reference point 110 and the cathode reference point 210 and transmit the optical signals to the first outlet end 11 and the second outlet end 12.

The lens unit 2 has at least two optical lenses. In this embodiment, the lens unit 2 has two optical lenses 21 and 22 disposed at the first outlet end 11 and the second outlet end 12 to receive the optical signals generated by the anode reference point 110 and the cathode reference point 210, respectively. The first and second optical lenses 21 and 22 are connected to the image conversion unit 3, which can convert the optical signals received by the first and second optical lenses 21 and 22 to an electronic signal.

The image conversion unit 3 is connected to the image processing and display unit 4 to generate a common image from the electronic signal and display the image on the same frame. The image processing and display unit 4 has an image overlap unit 41 and a display 42 connected to the image overlap unit 41. The image overlap unit 41 is used to perform an image overlap operation to the electronic signal converted by the image conversion unit 3 and display the alignment image on the display 42.

During the alignment process of the anode and cathode substrates 100 and 200, after the first and second optical lenses 21 and 22 are calibrated, the first and second optical lenses 21 and 22 along with the optical lens tube 1 can be integrally fixed on the first platform 5 as a reference for position adjustment. At the same time, the anode reference point 110 of the anode substrate 100 is aligned with the inlet end 10 of the optical lens tube 1 to let the anode reference point 110 correspond to the reflective translucent lens 13. The first platform 5 moves horizontally relative to the second platform 6 to drive the anode substrate 100 and the optical lens tube 1 to move horizontally so that the anode reference point 110 can move to focus at and align with the cathode reference point 210.

When the anode reference point 110 focuses at and aligns with the cathode reference point 210, the anode reference point 110 and the cathode reference point 210 can emit optical signals of the anode and the cathode to the corresponding inlet end 10 of the optical lens tube 1. These two optical signals can be transmitted to the reflective translucent lens 13 via the inlet end 10. Based on the translucent characteristic of the reflective translucent lens 13, the optical signals of the anode and the cathode can be emitted to the first outlet end 11 and the second outlet end 12, respectively. Using the first optical lens 21 at the first outlet end 11 and the second optical lens 22 at the second outlet end 12, the optical signals of the anode and the cathode can be detected, respectively.

The image conversion unit 3 connected to the first and second optical lenses 21 and 22 is then used to convert the optical signals to an electronic signal. The image processing and display unit 4 is used to generate and display the electronic signal on the same frame so as to accomplish optical alignment.

The reflective translucent lens 13 is disposed at a branch position 14 in the optical lens tube 1 with a certain angle. In this embodiment, the reflective translucent lens 13 is disposed at the branch position 14 in the optical lens tube 1 with an angle of 45°. Of course, other angles are also feasible. Using the optical characteristic of the reflective translucent lens 13 and collocated with the arranged angle of the reflective translucent lens 13 at the branch position 14, the optical signals of the anode and the cathode are emitted to the corresponding first and second outlet ends 11 and 12. Both the first and second optical lenses 21 and 22 are optical zoom lenses, and can be adjusted to align with a focused image center formed by the anode reference point 110 and the cathode reference point 210 so as to change the image capture range of the anode reference point 110 and the cathode reference point 210. The image conversion unit 3 has two image converters connected to the first and second optical lenses 21 and 22, respectively.

The present invention calibrates a plurality of optical lenses to correspondingly arrange them at a plurality of ends of the optical lens tube, and fixes the optical lens tube on the first platform that can move horizontally. The first platform is used for adjustment of the alignment position. The reference point of the anode substrate is placed in the image capture range of the corresponding optical lens. By means of vacuum adsorption, the anode substrate is disposed on the first platform. Through the motion of the first platform and the processing of the image overlap unit, the reference point of the anode substrate on the second platform is displayed in the working range of the display. The optical lenses are adjusted to focus at the anode and cathode reference points so as to make the overlap image clearer, thereby accomplishing optical alignment of the anode and cathode substrates.

Moreover, the optical lenses of the present invention are arranged in the optical lens tube to be fixed on the first platform. Therefore, during the operation, the optical lenses and the anode substrate are joined together to make a motion. Therefore it is not necessary to extra provide another reference point. The second platform can be used to shift or rotate the cathode substrate. In addition to effectively accomplishing optical alignment, the alignment operation can also be simplified.

To sum up, the present invention correspondingly arranges a plurality of optical lenses at a plurality of ends of the optical lens tube and makes use of the reflective translucent lens in the optical lens tube. The present invention has the following advantages:
1. A plurality of optical lenses having a common optical axis is used to accomplish image capture and alignment for the anode and cathode reference points at different focus depths.
2. A plurality of optical lenses jointly used for alignment of the anode and cathode reference points and correspondingly arranged at a plurality of ends of the optical lens tube is used to get a single coaxial optical image. Each optical lens can get the same common image, and the image capture range can be made wider.
3. The optical signals got by the optical lenses are processed by the image overlap unit to let the optical images be jointly input to the same display to accomplishing optical alignment of the anode and cathode substrates.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. An optical system for alignment assembly of field emission display panel, said optical system being used for alignment of reference points of a cathode substrate and an anode substrate, said anode and cathode substrates being arranged on a first platform and a second platform corresponding to each other, said optical system comprising:
an optical lens tube disposed on said first platform, said optical lens tube having an inlet end, a first outlet end, a second outlet end and a reflective translucent lens, said inlet end corresponding to said reference point of said anode substrate, said reflective translucent lens being disposed in said optical lens tube;
a lens unit having at least two optical lenses respectively corresponding to said first outlet end and said second outlet end;
an image conversion unit connected to said lens unit and used to convert an optical signal to an electronic signal;
an image processing and display unit connected to said image conversion unit and used to generate and display said electronic signal on the same frame;
whereby said first platform moves horizontally relative to said second platform to align said reference points of said anode and cathode substrates so as to produce two optical signals, which are transmitted to said reflective translucent lens via said inlet end and then respectively transmitted to said optical lenses at said first outlet end and said second outlet end via said reflective translucent lens, said image conversion unit then converts said optical signals to said electronic signal, and said image processing and display unit finally generates and displays said electronic signal on the same frame, thereby accomplishing optical alignment.

2. The optical system as claimed in claim 1, wherein said reflective translucent lens is disposed at a branch position of said optical lens tube with a certain angle to correspond to said inlet end, said first outlet end and said second outlet end.

3. The optical system as claimed in claim 1, wherein said two optical lenses are optical zoom lenses for adjusting and aligning a focused image center formed by said reference points.

4. The optical system as claimed in claim 1, wherein said optical lens tube and said lens unit are joined together and fixed on said first platform.

5. The optical system as claimed in claim 1, wherein said image conversion unit has at least two image converters connected to said optical lenses.

6. The optical system as claimed in claim 1, wherein said image processing and display unit has an image overlap unit and a display connected to said image overlap unit.

7. The optical system as claimed in claim 1, wherein a through hole corresponding to said inlet end of said optical lens tube is opened in said first platform so that said two optical signals can pass said through hole and said inlet end and then be transmitted to said reflective translucent lens when said reference point of said anode substrate is focused and aligned.

8. The optical system as claimed in claim 1, wherein said first platform is a movable, while said second platform is stationary.

9. The optical system as claimed in claim 1, wherein said first platform is a stationary, while said second platform is movable.

10. The optical system as claimed in claim 1, wherein both said first and second platform are movable.
